(19) United States
(12) Patent Application Publication
(10) Pub. No.: US 2026/0213994 A1
(43) Pub. Date: Jul. 23, 2026

(54) Apparatuses, Devices, Methods and Computer Programs for a Worker Node and an Edge Server

(71) Applicant: Intel Corporation, Santa Clara, CA (US)

(72) Inventors: Wenjian SHAO, Shanghai 31 (CN); Bin YANG, Shanghai (CN); Juguang ZHENG, Shanghai (CN); Yi QIAN, Shanghai (CN); Lingyun ZHU, Shanghai (CN)

(21) Appl. No.: 19/142,263

(22) PCT Filed: Dec. 28, 2022
(86) PCT No.: PCT/CN2022/143001

§ 371 Date: Jun. 23, 2025

(51) Int. Cl. H04L 41/0803; H04L 41/16; H04L 47/24

(52) U.S. Cl. CPC H04L 41/0803; H04L 41/16; H04L 47/24

(57) ABSTRACT

Various examples relate to apparatuses, devices, methods and computer programs for an edge worker node and an edge server, to an edge worker node and an edge server, and to a system comprising an edge server and one or more edge worker nodes. An apparatus comprises processing circuitry to determine information on a network quality of a network connection between the edge worker node and an edge server, select, based on the network quality, a network configuration, the network configuration comprising at least one of a network protocol and a prioritization strategy for communicating via the network connection, and to communicate via the network connection according to the selected network configuration.

### BACKGROUND

To efficiently manage a microservice cluster and orchestrate workload in the cluster, a large amount of network communication occurs among nodes within a cluster, such as internal and external control commands, telemetry for reporting status and resource utilization, observation information for logging and tracing events, etc. So, a stable network with abundant bandwidth and low latency may be beneficial to the operation of a microservice cluster. Accordingly, cluster communication mechanism work well in a good network infrastructure, such as the network infrastructure of a cloud service provider.

However, in edge computing scenarios, especially on-premise edge computing, the network infrastructure might not be as good as within the cloud in terms of connectivity, bandwidth, and latency. Moreover, the quality of the network often changes dynamically. The cluster communication mechanism designed for cloud infrastructure might not work as well when it is deployed in the edge infrastructure, which may lead to instability or even cause exceptions in the microservice cluster.

In some systems, instable network conditions are dealt with by increasing the tolerance for abnormal transfers. For example, in Kubernetes, a microservice orchestration framework, the empirical parameters may be selected to match the network conditions of the nodes when deploying the cluster. To make sure a node and pods running on a node serve properly, three parameters, i.e., node-monitor-period, node-monitor-grace-period and pod-eviction-timeout, are set to control the node status update frequency and period to determine whether a node should be disconnected and migrate pods upon it to other nodes in the cluster. To tolerate instable network among some edge nodes, loose parameters can be configured for these edge nodes.

### BRIEF DESCRIPTION OF THE FIGURES

Some examples of apparatuses and/or methods will be described in the following by way of example only, and with reference to the accompanying figures, in which

FIG. 1a shows a schematic diagram of an example of an apparatus or device for an edge worker node, and of an edge worker node comprising such an apparatus or device;

FIG. 1b shows a flow chart of an example of a method for an edge worker node;

FIG. 2a shows a schematic diagram of an example of an apparatus or device for an edge server, and of an edge server comprising such an apparatus or device;

FIG. 2b shows a flow chart of an example of a method for an edge server;

FIG. 3 shows a schematic diagram of an example of an on-premises edge-based microservice cluster; and

FIG. 4 shows a schematic diagram of a microservice cluster communicating according to an example of the proposed concept.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

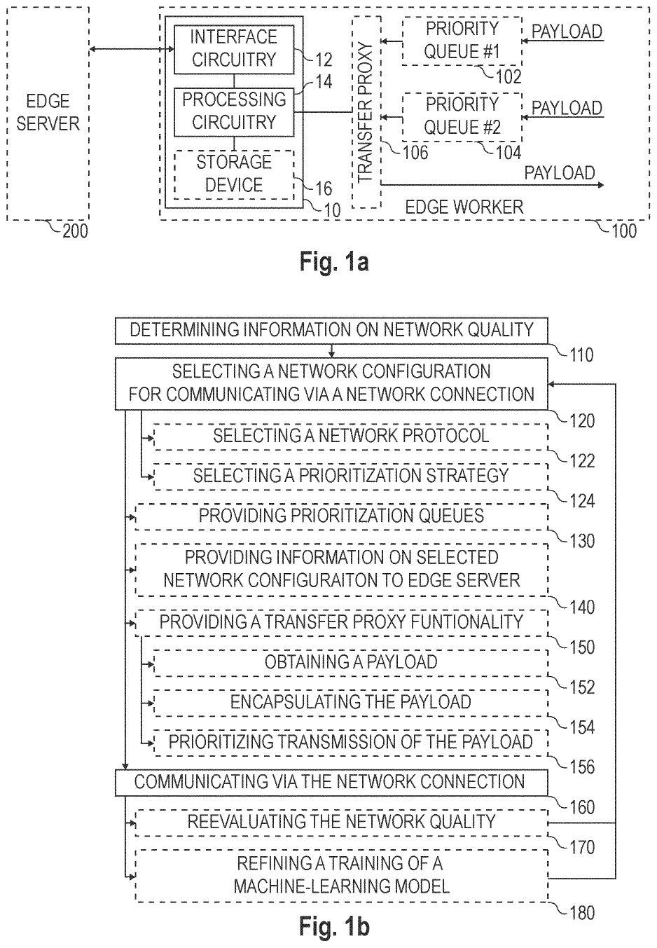

FIG. 1a shows a schematic diagram of an example of an apparatus 10 or device 10 for an edge worker node 100, and of an edge worker node 100 comprising such an apparatus 10 or device 10. The apparatus 10 comprises circuitry to provide the functionality of the apparatus 10. For example, the circuitry of the apparatus 10 may be configured to provide the functionality of the apparatus 10. For example, the apparatus 10 of FIG. 1a comprises interface circuitry 12, processing circuitry 14 and (optional) storage circuitry 16. For example, the processing circuitry 14 may be coupled with the interface circuitry 12 and with the storage circuitry 16. For example, the processing circuitry 14 may provide the functionality of the apparatus, in conjunction with the interface circuitry 12 (for exchanging information, e.g., with other components inside or outside the worker node 100 comprising the apparatus or device 10, such as an edge server 200) and the storage circuitry 16 (for storing information, such as machine-readable instructions). Likewise, the device 10 may comprise means for providing the functionality of the device 10. For example, the means may be configured to provide the functionality of the device 10. The components of the device 10 are defined as component means, which may correspond to, or implemented by, the respective structural components of the apparatus 10. For example, the device 10 of FIGS. 1a and 1b comprises means for processing 14, which may correspond to or be implemented by the processing circuitry 14, means for communicating 12, which may correspond to or be implemented by the interface circuitry 12, and (optional) means for storing information 16, which may correspond to or be implemented by the storage circuitry 16. In general, the functionality of the processing circuitry 14 or means for processing 14 may be implemented by the processing circuitry 14 or means for processing 14 executing machine-readable instructions. Accordingly, any feature ascribed to the processing circuitry 14 or means for processing 14 may be defined by one or more instructions of a plurality of machine-readable instructions. The apparatus 10 or device 10 may comprise the machine-readable instructions, e.g., within the storage circuitry 16 or means for storing information 16.

The processing circuitry 14 or means for processing 14 is to execute the machine-readable instructions to determine information on a network quality of a network connection between the edge worker node 100 and an edge server 200. The processing circuitry 14 or means for processing 14 is to select, based on the network quality, a network configuration. The network configuration comprises at least one of a network protocol and a prioritization strategy for communicating via the network connection. The processing circuitry 14 or means for processing 14 is to communicate via the network connection (e.g., via the interface 12) according to the selected network configuration.

FIG. 1a further shows a system comprising the worker node 100 (with the apparatus 10 or device 10) and the edge server 200. For example, both the edge worker node and the edge server 200 may be (server) computer systems, e.g., servers. The edge server may be a server for coordinating a plurality of worker nodes located at the edge, i.e., located remotely from the edge server. In other words, the edge worker nodes may be servers that provide functionality “at the edge”, e.g., on premises, or at a base station of a mobile communication system. For example, the edge worker nodes may be located “at the edge”, in contrast to “in the cloud”, where microservices are usually hosted. For example, the edge server may implement a control plane of an edge-based microservice cluster, with the edge worker nodes providing the microservices (at the edge). Accordingly, the system may be an edge-based microservice system, with the edge server controlling the instances of microservices provided by the worker node(s). Accordingly, the network connection may be used for administrative communication among nodes of the cluster of microservices, with the cluster of microservices comprising the edge worker node and the edge server.

FIG. 1b shows a flow chart of an example of a corresponding method for an edge worker node, such as the edge worker node 100 of FIG. 1a. The method comprises determining 110 the information on the network quality of the network connection between the edge worker node 100 and the edge server 100. The method further comprises selecting 120, based on the network quality, the network configuration. The method comprises communicating 160 via the network connection according to the selected network configuration. For example, the method may be performed by the edge worker node 100 (i.e., by a computer system), e.g., the apparatus 10 or device 10 of the edge worker node 100.

In the following, the functionality of the apparatus 10, the device 10, the method, of a corresponding computer program, and of the edge worker node 100 is illustrated with respect to the apparatus 10. Features introduced in connection with the apparatus 10 may likewise be included in the corresponding device 10, method, computer program and edge worker node.

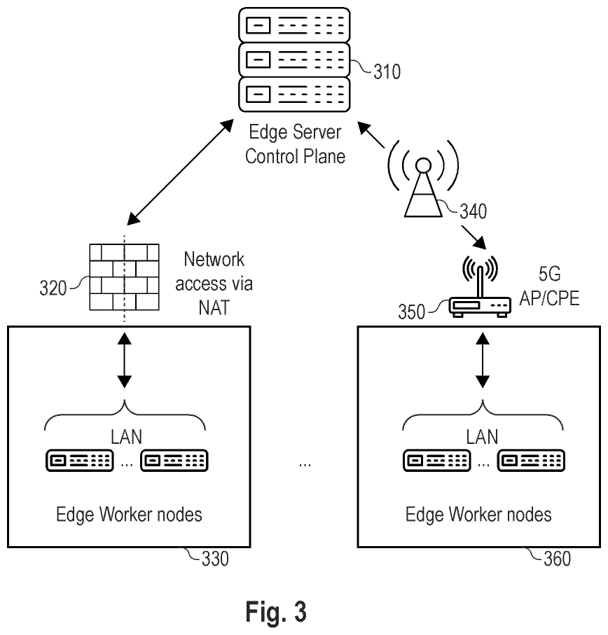

Various examples of the present disclosure relate to the communication between an edge worker node an edge server. In this context, the edge worker node is a server that is located “at the edge” (i.e., in close physical proximity with the client devices it is to serve), while the edge server is a server for controlling the edge worker nodes. In some examples, the edge server may also be located at the edge (albeit in a different location than the edge worker node), or the edge server may be located in the cloud. In this context, the edge server is a server for controlling edge worker nodes that are located at the edge. The edge server itself is not necessarily located at the edge. On the contrary, as shown in FIG. 3, the edge server is preferably located in the cloud, so it can communicate equally well with a large number of worker nodes of the microservice cluster (located at different locations, and communicating via different communication connections).

In the present disclosure, the proposed concept is based on the insight, that the communication between edge worker nodes and edge server can be unreliable and/or be subject to changing network quality. This is particularly the case if the connection between the edge worker node and the edge server leads via a shared medium, such as a wireless communication network or a cable modem-based communication network. In this case, depending on the utilization of the network (and, in case of a wireless connection, the weather), the quality of the network may fluctuate severely, which may lead to a large range of latencies, packet loss rates, throughput etc. In other systems, this large range is “factored in” by using loose parameters for aspects such as node-monitor-period, node-monitor-grace-period and pod-eviction-timeout. However, even if such parameters are chosen loosely, the performance of the microservice cluster may deteriorate, as a suitable workload distribution and scaling up and down of instances is a vital process to adjust the microservice cluster to the demand posed by the clients. In the proposed concept, instead of tolerating bad network performance, measures are taken for mitigating bad network performance, while attempting the keep the (computational) overhead low.

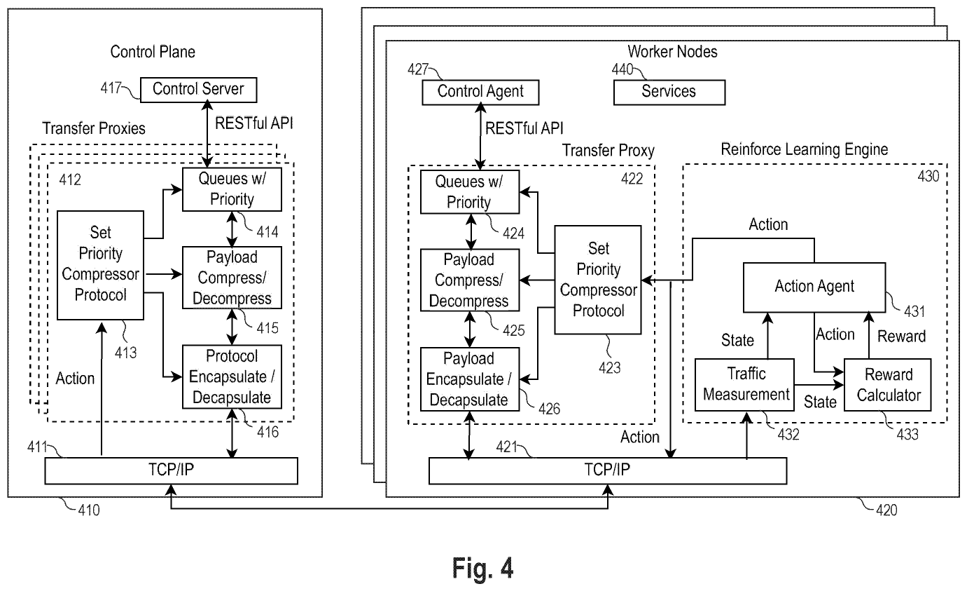

The proposed concept starts by determining the quality of the network connection. Thus, the processing circuitry determines the information on the network quality. For example, as shown in FIG. 4, the processing circuitry may collect information from a network stack (such as a Transmission Control Protocol/Internet Protocol, TCP/IP) stack of the worker node. For example, the information on the network quality may comprise at least one of a (average and/or maximal) packet transmission latency, a (average and/or maximal) packet loss rate, a (average or maximal) number of retransmissions, a (average or maximal) bit error rate of communications via the network connection between the edge worker node and the edge server 200.

For example, the processing circuitry may categorize the network quality into one of two or more levels, e.g., into two levels (e.g., “higher network quality” and “lower network quality”), three levels (e.g., “higher network quality”, “medium network quality”, “lower network quality”) or four levels (e.g., “high quality”, “normal quality”, “poor quality” and “worse/worst quality”, as proposed in connection with FIG. 4). More generally, the network quality may be categorized into a first to n-th network quality, based on n−1 thresholds.

Depending on the network quality, a network configuration is selected. In other words, the network configuration may be selected according to the network quality. In the proposed concept, two dimensions are provided for selecting the network configuration—the network protocol dimension, and the prioritization strategy. In this context, the network protocol dimension relates to the network protocol being used. For example, for communication between a microservice control plane and a worker node, in most cases, a RESTful (Representational State Transfer) API (Application Programming Interface) that is transmitted via the first version of the HyperText Transmission Protocol (HTTP) is used. However, while this protocol is in wide use and broadly supported by the microservice orchestration tools and the microservices themselves, it may be considered inefficient (due to the overhead generated by the uniform resource locator (URL) scheme being used) and less adept at lower-quality network connections (due to the lack of inbuilt handling of transmission errors). Therefore, this base protocol may be translated into another protocol requiring less bits to transmit the same information, and/or into another protocol that is more adept at handling transmission errors. For example, the processing circuitry may select the network protocol of the network configuration, e.g., among a group of at least two network protocols. Accordingly, as further shown in FIG. 1b, the method may comprise selecting 122 the network protocol of the network configuration among the group of at least two network protocols. For example, the at least two network protocols may require different amounts of bits for transmitting the same information, and/or they may include different capabilities with respect to transmission error handling. For example. For example, the group of at least two network protocols may comprise two or more of a HTTP-based REST API-based protocol, a Remote Procedure Call (RPC) protocol (such as gRPC), a Message-Queuing Telemetry Transport (MQTT) protocol, and a compressed MQTT protocol. For example, the HTTP-based REST API-based protocol may require the most bits for transmitting the same information, while having the least transmission error handling capabilities. On the other side of the spectrum, the compressed MQTT protocol requires the least bits for transmitting the same information, while have better transmission error handling capabilities than the HTTP-based REST API-based protocol. However, the compressed MQTT protocol is also the computationally most expensive of the cited protocols, as it involves both protocol translation and compression. For this reason, a tradeoff may be chosen between number of bits required/transmission error handling on the one hand, and computational complexity on the other hand.

The second potential aspect of the network configuration is the prioritization strategy. In this context, the prioritization strategy indicates which types of messages are to be prioritized or deprioritized. In other words, the prioritization strategy indicates one or more types of messages to be prioritized or one or more types of messages to be deprioritized. For example, the prioritization may affect a number of retransmissions being performed, a use of forward error correction, a use of preemptive retransmission etc. Similar to the selection of the communication protocol, the processing circuitry may select the prioritization strategy of the network configuration among a group of at least two pre-defined prioritization strategies. Accordingly, as further shown in FIG. 1b, the method may comprise selecting 124 the prioritization strategy of the network configuration among the group of at least two pre-defined prioritization strategies. These prioritization strategies may differ with respect to the types of messages being prioritized/deprioritized. For example, in the following, four different types of messages are distinguished-logging and/or tracing messages, telemetry messages, control command messages and alert messages. Of these messages, the alert messages may be considered the most important, as they are used to alert the edge server of an exception having occurred at an edge worker node. This is followed by the control command messages, which are messages includeing commands exchanged between the edge server and the edge worker nodes, e.g., to start/stop instances of microservices, to scale up/down, to change the routing etc. Telemetry messages come next, as they are usually the basis of decisions taken by the edge server, i.e., the control command messages are often based on the telemetry provided by the edge worker nodes. The final, and least critical, type of messages are logging/tracing messages, which are primarily relevant for debugging. Accordingly, the group of at least two pre-defined prioritization strategies may comprise a prioritization strategy wherein (all types of) messages have the same priority, a prioritization strategy wherein logging and/or tracing messages are deprioritized, a prioritization strategy wherein logging and/or tracing messages and telemetry messages are deprioritized and a prioritization strategy wherein logging and/or tracing messages, telemetry messages and control command messages are deprioritized. It is evident, that, depending on the prioritization strategy chosen, different amounts of messages are deprioritized, from none (when all messages are prioritized equally) to all but the alert messages (in the final prioritization strategy listed above). Accordingly, the first (where all messages are prioritized equally) may be used when the network quality is good, while the last (where all but the alert messages are deprioritized) may be used when the network quality is poor. However, in any network condition, it is desirable for all messages to be delivered reliably, so, similar to the protocol selection, a tradeoff may be chosen.

To implement the above prioritization strategies, the different types of messages may be assigned to different prioritization queues. For example, as further shown in FIG. 1a, the processing circuitry may provide two or more different prioritization queues 102, 104 for two or more different types of messages, e.g., one for each type of message, or one for each priority. Accordingly, as further shown in FIG. 1b, the method may comprise providing 130 two or more different prioritization queues 102, 104 for two or more different types of messages. For example, the queues may be provided by a transfer proxy functionality 106.

When the network configuration has been determined at the edge worker node (i.e., the network configuration is edge worker node-specific, it may be communicated to the edge server, so the edge server can use it to a) decode messages received from the edge worker node, and b) also encode/prioritize messages transmitted to the edge worker node according to the network configuration. In other words, the processing circuitry may provide information on the selected network configuration to the edge server. Accordingly, as further shown in FIG. 1, the method may comprise providing 140 information on the selected network configuration to the edge server. For example, a control message comprising the information on the selected network configuration may be transmitted to the edge server. For example, the information on the selected network configuration may indicate at least one of the protocol selected and the prioritization strategy selected.

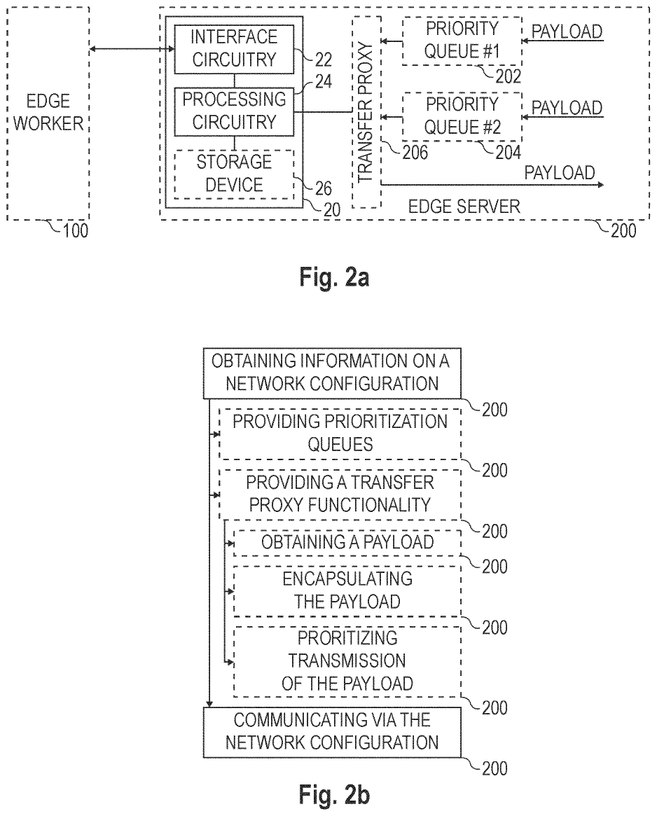

The use of clusters of microservices for providing a complex application is a common implementation strategy. Therefore, a large ecosystem is already established for managing and orchestrating such clusters of microservices. Adapting this large ecosystem to the proposed concept, by requiring that each control server (on the edge server) and control agent (on the edge worker node) support a multitude of network configuration may lead to large challenges, and thus likely a delayed rollout of the proposed concept. To facilitate this rollout, the proposed functionality may be encompassed in a transfer proxy. This transfer proxy is shown as transfer proxy 106 in FIG. 1a/transfer proxy 422 in FIG. 4 (for the edge worker node) and transfer proxy 206 in FIG. 2a/transfer proxy 412 in FIG. 4 (for the edge server/control plane). Thus, the processing circuitry may provide a transfer proxy functionality 106 for communicating via the network connection. Accordingly, as further shown in FIG. 1b, the method may comprise providing 150 the transfer proxy functionality 106 for communicating via the network connection. This transfer proxy functionality is configured to transfer a payload via the network communication according to the selected network configuration. For example, the payload may comprise or correspond to the message(s) being exchanged between the edge server and the edge worker node(s). In particular, the transfer proxy functionality may be used to transfer the payload, according to the selected network configuration, to and from the edge server. Starting from the control agent (427 in FIG. 4), this may include obtaining the payload, (optionally) sorting the payload into one of the prioritization queues, (optionally) compressing the payload according to the network protocol, (optionally) encapsulating the payload according to the network protocol and transmitting the payload to the edge server (i.e., to the transfer proxy 206/412 of the edge server) according to the network protocol. Starting from the edge server, this may include receiving the payload according to the selected network protocol from the edge server (i.e., from the transfer proxy 206/412 of the edge server), (optionally) decapsulating the payload according to the network protocol, (optionally) decompressing the payload according to the network protocol, and providing the payload to the control agent. Various tasks above are marked as optional, as not every network configuration requires them—if the network quality is good and a HTTP REST API is used, none of the optional tasks may be required, and the payload may be transmitted “as is”. However, if one of the latter prioritization schemes are used, and MQTT with payload compression is used, each of the optional tasks may be used.

As is evident from the above sequence, when transmitting information to the edge server, the following tasks may be involved. For example, the processing circuitry may obtain, by the transfer proxy functionality, e.g., via a HTTP REST API, the payload to be transmitted via the network connection, and (optionally) encapsulate the payload (optionally including compressing the payload), and/or (optionally) prioritize transmission of the payload according to the selected network configuration. Accordingly, as further shown in FIG. 1b, the method may comprise obtaining 152, by the transfer proxy functionality, the payload to be transmitted via the network connection, and (optionally) encapsulating 154 the payload (optionally including compressing the payload) and/or prioritizing 156 transmission of the payload according to the selected network configuration. On the receiving side, the processing circuitry may receive, by the transfer proxy functionality, the payload according to the selected network configuration, (optionally) decapsulate/decompress the payload, and provide the payload, e.g., via a HTTP REST API, e.g., to a control agent of the edge worker node.

Thus, the transfer proxy may implement the communication according to the selected network configuration. Alternatively, the control agent itself may implement at least the communication according to the selected configuration, and optionally, also the selection of the network configuration.

As outlined above, the communication between edge server and edge worker node may be made less predictable by rapid and substantial changes in the network quality. Therefore, the proposed concept may be repeated in regular intervals. For example, the processing circuitry may periodically reevaluate the network quality (by periodically determining the network quality) and repeat the selection of the network configuration based on the reevaluated network quality. Accordingly, as further shown in FIG. 1b, the method may comprise periodically reevaluating 170 the network quality and repeating the selection 120 of the network configuration based on the reevaluated network quality.

In the above examples, a straightforward and deterministic mapping between network quality and selected network protocol was used as an example. However, such a deterministic mapping may lead to less than ideal results, as it is based on assumptions that are made at time of implementation. To further improve the outcome, a machine learning-based approach may be used, where the selection of the network configuration is done by a machine-learning model that is trained during operation of the worker node to iteratively improve the selections being made. For example, the apparatus may comprise memory circuitry 16 (e.g., the storage circuitry 16 in FIG. 1a) comprising a machine-learning model. The machine-learning model may be trained, using reinforcement learning, to select the network configuration according to a reward function. The processing circuitry may select the network configuration using the machine-learning model. Accordingly, as further shown in FIG. 1b, the method may comprise using the machine-learning model to select 120 the network configuration. For example, the information on the network quality may be used as input to the machine-learning model. The information on the network quality may represent the state on which a reinforcement learning-based actor acts.

Machine learning refers to algorithms and statistical models that computer systems may use to perform a specific task without using explicit instructions, instead relying on models and inference. For example, in machine-learning, instead of a rule-based transformation of data, a transformation of data may be used, that is inferred from an analysis of historical and/or training data. For example, the content of images may be analyzed using a machine-learning model or using a machine-learning algorithm. In order for the machine-learning model to analyze the content of an image, the machine-learning model may be trained using training images as input and training content information as output. By training the machine-learning model with a large number of training images and associated training content information, the machine-learning model “learns” to recognize the content of the images, so the content of images that are not included of the training images can be recognized using the machine-learning model. The same principle may be used for other kinds of sensor data as well: By training a machine-learning model using training sensor data and a desired output, the machine-learning model “learns” a transformation between the sensor data and the output, which can be used to provide an output based on non-training sensor data provided to the machine-learning model.

Machine-learning models are trained using training input data. The examples specified above use a training method called “supervised learning”. In supervised learning, the machine-learning model is trained using a plurality of training samples, wherein each sample may comprise a plurality of input data values, and a plurality of desired output values, i.e., each training sample is associated with a desired output value. By specifying both training samples and desired output values, the machine-learning model “learns” which output value to provide based on an input sample that is similar to the samples provided during the training.

In the proposed machine-learning model, reinforcement learning is used. Reinforcement learning is another group of machine-learning algorithms. In reinforcement learning, one or more software actors (called “software agents”) are trained to take actions in an environment. Based on the taken actions, a reward is calculated. Reinforcement learning is based on training the one or more software agents to choose the actions such, that the cumulative reward is increased, leading to software agents that become better at the task they are given (as evidenced by increasing rewards).

In the proposed concept, one (or two) software actors are trained to select the network configuration, e.g., to select the network protocol and/or the prioritization strategy. This training is based on the above-referenced reward function. A detailed example of such a reward function is given in connection with FIG. 4. However, in the following, some basic principles behind the reward function discussed in connection with FIG. 4 are discussed.

In general, the reward function may embody the tradeoff(s) identified above—the tradeoff between the success rate (i.e., that the (relevant) messages are delivered successfully) and computational complexity. In connection with FIG. 4, this tradeoff is mirrored by equation (1): R=Rₛᵣ+R_{proxy}, with Rₛᵣ being a component of the reward that is based on the success rate, and with R_{proxy} being a component of the reward that is based on the computational complexity. Accordingly, the reward function may be based on a success rate of the communication and based on a complexity of the network configuration. For example, Rₛᵣ may be higher, the higher the success rate, while R_{proxy} may be lower (or more negative), the higher the computational complexity.

As outlined above, different types of messages may be exchanged by the edge worker node and the edge server, with some types of messages (e.g., alert messages) being more important than other messages (e.g., logging/tracing messages). Accordingly, the success rate, and the reward being calculated based on the success rare, may take into account the relative importance of the different types of message. For example, the success rate may be determined according to a weighted combination of success rates of different types of messages. In connection with FIG. 4, a weighting factor (W) is defined for each type of message to determine the overall success rate based on the success rates (SR) of the respective types of messages:

$$S {R}_{overall} = \frac{{W}_{l} \cdot {SR}_{l} + {W}_{t} \cdot {SR}_{t} + {W}_{c} \cdot {SR}_{c} + {W}_{a} \cdot {SR}_{a}}{{W}_{l} + {W}_{t} + {W}_{c} + {W}_{a}}$$

The complexity of the network configuration depends on the network protocol and prioritization strategy chosen. Accordingly, the complexity of the network configuration may be determined based on the selected network protocol and based on the selected prioritization strategy. In connection with FIG. 4, this is expressed by equation (4): R_{proxy}=R_{protocol}+R_{strategy}.

To determine the respective components R_{protocol}+R_{strategy}, (at least) two cases may be distinguished-a “pass” or “good” case, where the success rate is at least as good as threshold, and a “fail” or “bad” case, where it is not. Depending on the case, different rewards may be calculated for R_{protocol}+R_{strategy}. In other words, the complexity of the network configuration may be determined depending on the success rate, such that, depending on the success rate, a different combination of network protocol and prioritization strategy is prioritized. For example, if a lower-complexity protocol or a prioritization strategy with fewer messages being deprioritized is selected and the success rate is lower than a threshold, the reward of this selection may be low, as the desired success rate is not reached. In this case, the reward being produced may be selected such, that it encourages the actor/agent to select a combination with a higher-complexity protocol or prioritization strategy with more messages being deprioritized. If, on the other hand, a higher-complexity protocol or a prioritization strategy with more messages being deprioritized is selected and the success rate is higher than the threshold, also a lor reward may be output. In this case, the reward being produced may be selected such, that it encourages the actor/agent to select a combination with a lower-complexity protocol or prioritization strategy with fewer messages being deprioritized. In the end, a tradeoff between computational complexity and success rate may be obtained.

This reinforcement learning approach may be applied during selection of the network configuration. It starts with a pre-trained machine-learning model (which is trained outside the worker node), which is then continually improved by evaluating the effect of the selected network configuration. Accordingly, the machine-learning model may be a pre-trained machine-learning model. The processing circuitry may refine the training of the pre-trained machine-learning model during operation of the worker node. Accordingly, the method may comprise refining 180 the training of the pre-trained machine-learning model during operation of the worker node. For example, the success rate and the computational complexity may be calculated (based on the real-world communication of the worker node) for a pre-defined timer-interval after a network configuration is selected. Based on the success rate and computational complexity, the reward may be calculated and used to refine the training of the machine-learning model.

The interface circuitry 12 or means for communicating 12 may correspond to one or more inputs and/or outputs for receiving and/or transmitting information, which may be in digital (bit) values according to a specified code, within a module, between modules or between modules of different entities. For example, the interface circuitry 12 or means for communicating 12 may comprise circuitry configured to receive and/or transmit information.

For example, the processing circuitry 14 or means for processing 14 may be implemented using one or more processing units, one or more processing devices, any means for processing, such as a processor, a computer or a programmable hardware component being operable with accordingly adapted software. In other words, the described function of the processing circuitry 14 or means for processing may as well be implemented in software, which is then executed on one or more programmable hardware components. Such hardware components may comprise a general-purpose processor, a Digital Signal Processor (DSP), a micro-controller, etc.

For example, the storage circuitry 16 or means for storing information 16 may comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

For example, the edge worker node 100 may be a server computer system, i.e., a computer system being used to serve functionality, such as one or more instances of one or more microservices, to one or more client computers.

Machine-learning algorithms are usually based on a machine-learning model. In other words, the term “machine-learning algorithm” may denote a set of instructions that may be used to create, train or use a machine-learning model. The term “machine-learning model” may denote a data structure and/or set of rules that represents the learned knowledge, e.g., based on the training performed by the machine-learning algorithm. In embodiments, the usage of a machine-learning algorithm may imply the usage of an underlying machine-learning model (or of a plurality of underlying machine-learning models). The usage of a machine-learning model may imply that the machine-learning model and/or the data structure/set of rules that is the machine-learning model is trained by a machine-learning algorithm.

For example, the machine-learning model may be an artificial neural network (ANN). ANNs are systems that are inspired by biological neural networks, such as can be found in a brain. ANNs comprise a plurality of interconnected nodes and a plurality of connections, so-called edges, between the nodes. There are usually three types of nodes, input nodes that receiving input values, hidden nodes that are (only) connected to other nodes, and output nodes that provide output values. Each node may represent an artificial neuron. Each edge may transmit information, from one node to another. The output of a node may be defined as a (non-linear) function of the sum of its inputs. The inputs of a node may be used in the function based on a “weight” of the edge or of the node that provides the input. The weight of nodes and/or of edges may be adjusted in the learning process. In other words, the training of an artificial neural network may comprise adjusting the weights of the nodes and/or edges of the artificial neural network, i.e., to achieve a desired output for a given input. In at least some embodiments, the machine-learning model may be deep neural network, e.g., a neural network comprising one or more layers of hidden nodes (i.e., hidden layers), preferably a plurality of layers of hidden nodes.

Alternatively, the machine-learning model may be a support vector machine. Support vector machines (i.e., support vector networks) are supervised learning models with associated learning algorithms that may be used to analyze data, e.g., in classification or regression analysis. Support vector machines may be trained by providing an input with a plurality of training input values that belong to one of two categories. The support vector machine may be trained to assign a new input value to one of the two categories. Alternatively, the machine-learning model may be a Bayesian network, which is a probabilistic directed acyclic graphical model.

A Bayesian network may represent a set of random variables and their conditional dependencies using a directed acyclic graph. Alternatively, the machine-learning model may be based on a genetic algorithm, which is a search algorithm and heuristic technique that mimics the process of natural selection.

More details and aspects of the apparatus 10, device 10, method, computer program and worker node 100 are mentioned in connection with the proposed concept or one or more examples described above or below (e.g., FIGS. 2a to 4). The apparatus 10, device 10, method, computer program and worker node 100 may comprise one or more additional optional features corresponding to one or more aspects of the proposed concept, or one or more examples described above or below.

FIG. 2a shows a schematic diagram of an example of an apparatus 20 or device 20 for an edge server 200, and of an edge server 200 comprising such an apparatus 20 or device 20. The apparatus 20 comprises circuitry to provide the functionality of the apparatus 20. For example, the circuitry of the apparatus 20 may be configured to provide the functionality of the apparatus 20. For example, the apparatus 20 of FIG. 2a comprises interface circuitry 22, processing circuitry 24 and (optional) storage circuitry 26. For example, the processing circuitry 24 may be coupled with the interface circuitry 22 and with the storage circuitry 26. For example, the processing circuitry 24 may provide the functionality of the apparatus, in conjunction with the interface circuitry 22 (for exchanging information, e.g., with other components inside or outside the edge server 200 comprising the apparatus or device 20, e.g., with one or more edge worker nodes 100) and the storage circuitry 26 (for storing information, such as machine-readable instructions). Likewise, the device 20 may comprise means for providing the functionality of the device 20. For example, the means may be configured to provide the functionality of the device 20. The components of the device 20 are defined as component means, which may correspond to, or implemented by, the respective structural components of the apparatus 20. For example, the device 20 of FIGS. 2a and 2b comprises means for processing 24, which may correspond to or be implemented by the processing circuitry 24, means for communicating 22, which may correspond to or be implemented by the interface circuitry 22, and (optional) means for storing information 26, which may correspond to or be implemented by the storage circuitry 26. In general, the functionality of the processing circuitry 24 or means for processing 24 may be implemented by the processing circuitry 24 or means for processing 24 executing machine-readable instructions. Accordingly, any feature ascribed to the processing circuitry 24 or means for processing 24 may be defined by one or more instructions of a plurality of machine-readable instructions. The apparatus 20 or device 20 may comprise the machine-readable instructions, e.g., within the storage circuitry 26 or means for storing information 26.

The processing circuitry 24 or means for processing 24 is to obtain, from an edge worker node 100, information on a network configuration to be used for communicating, via a network connection, with an edge worker node 100. The network configuration comprises at least one of a network protocol and a prioritization strategy for communicating via the network connection. The network configuration is selected according to a network quality of the network connection. The processing circuitry 24 or means for processing 24 is to communicate via the network connection (e.g., via the interface 22) according to the selected network configuration.

FIG. 2a further shows a system comprising the edge server 200 (with the apparatus 20 or device 20) and one or more edge worker nodes 100 (e.g., a plurality of edge worker nodes 100).

FIG. 2b shows a flow chart of an example of a corresponding method for an edge server, e.g., for the edge server 200 of FIG. 2a. The method comprises obtaining 210, from the edge worker node 100, the information on the network configuration to be used for communicating, via the network connection, with the edge worker node. The method comprises communicating 240 via the network connection (with the respective edge worker node 100) according to the selected network configuration.

In the following, the functionality of the apparatus 20, the device 20, the method, of a corresponding computer program, and of the edge server 200 is illustrated with respect to the apparatus 20. Features introduced in connection with the apparatus 20 may likewise be included in the corresponding device 20, method, computer program and edge server.

As outlined in connection with FIGS. 1a and/or 1b, the proposed concept relates to a communication between edge worker nodes and an edge server, and in particular to administrative communication among nodes of a cluster of microservices, with the cluster of microservices comprising the edge worker nodes (providing the microservices) and the edge server (as control plane). On both sides, similar techniques may be employed with respect to the communication being performed. However, in the proposed concept, the selection of the network configuration is performed by the individual worker nodes. The edge server, on the other side of the communication, is merely informed about the network configuration that is selected by the worker nodes, and applies the network configuration selected by the worker nodes, on a per-worker node (or per-site) basis.

Accordingly, the processing circuitry obtains, from the (or each) edge worker node 100, information on a network configuration to be used for communicating, via a network connection, with the respective edge worker node. For example, this information on the network configuration is determined by the respective edge worker node 100, e.g., by the apparatus 10 or device 10 of the respective edge worker node 100. It is then used to communicate via the network connection, according to the selected network configuration. Similar to the edge worker node, the control server (e.g., control server 417 in FIG. 4) may be configured to communicate according to the selected network configuration. Alternatively, similar to some examples of the the edge worker node described in connection with FIGS. 1a and/or 1b, a transfer proxy functionality may be provided.

In other words, the processing circuitry may provide a transfer proxy functionality 206 for communicating via the network connection. Accordingly, as further shown in FIG. 2b, the method may comprise providing 230 the transfer proxy functionality 106 for communicating via the network connection. As described in connection with FIGS. 1a and/or 1b, the transfer proxy functionality is configured to transfer a payload via the network communication according to the selected network configuration. In particular, the transfer proxy functionality is used to transfer the payload, according to the selected network configuration, to and from the respective edge worker node. As the network connections between the edge server and the different edge worker nodes can differ with respect to the network quality they provide, not only one instance of the transfer proxy functionality may be provided, but multiple instances, e.g., one for each worker node, or one for each communication channel (if the same communication channel is used by multiple worker nodes, as shown in FIG. 3). For example, the processing circuitry may obtain the information on the network configuration to be used from a plurality of different edge worker nodes, and to provide a separate instance of the transfer proxy functionality for each of the plurality of different edge worker nodes. Accordingly, as shown in FIG. 2b, the method may comprise obtaining 210 the information on the network configuration to be used from a plurality of different edge worker nodes, and providing 230 a separate instance of the transfer proxy functionality for each of the plurality of different edge worker nodes.

The transfer proxy functionality used for the edge server is similar to the transfer proxy functionality used for the edge worker nodes (described in connection with FIGS. 1a and/or 1b). Starting from the control server (417 in FIG. 4), this may include obtaining the payload, (optionally) sorting the payload into one of the prioritization queues, (optionally) compressing the payload according to the network protocol, (optionally) encapsulating the payload according to the network protocol and transmitting the payload to the respective edge worker node (i.e., to the transfer proxy 106/422 of the edge worker node) according to the network protocol. Starting from the respective edge worker node, this may include receiving the payload according to the selected network protocol from the edge server (i.e., from the transfer proxy 106/422 of the edge worker node), (optionally) decapsulating the payload according to the network protocol, (optionally) decompressing the payload according to the network protocol, and providing the payload to the control server. Again, various tasks above are marked as optional, as not every network configuration requires them.

As is evident from the above sequence, when transmitting information to an edge worker node, the following tasks may be involved, the processing circuitry may obtain (e.g., via a HTTP REST API), by the transfer proxy functionality, the payload to be transmitted via the network connection, and (optionally) encapsulate the payload (optionally including compressing the payload) and/or (optionally) prioritize transmission of the payload according to the selected network configuration. Accordingly, as further shown in FIG. 2b, the method may comprise obtaining 232, by the transfer proxy functionality, the payload to be transmitted via the network connection, and (optionally) encapsulating 234 the payload (optionally including compressing the payload) and/or prioritizing 236 transmission of the payload according to the selected network configuration. On the receiving side, the processing circuitry may receive, by the transfer proxy functionality, the payload according to the selected network configuration, (optionally) decapsulate/decompress the payload, and provide the payload, e.g., via a HTTP REST API, e.g., to the control server of the edge server.

Thus, the transfer proxy may implement the communication according to the selected network configuration. Alternatively, the control agent itself may implement at least the communication according to the selected configuration, and optionally, also the selection of the network configuration.

To implement support for different prioritization strategies, different types of messages obtained from the control server may be assigned to different prioritization queues. For example, as further shown in FIG. 2a, the processing circuitry may provide two or more different prioritization queues 202, 204 for two or more different types of messages, e.g., one for each type of message, or one for each priority. Accordingly, as further shown in FIG. 2b, the method may comprise providing 220 two or more different prioritization queues 202, 204 for two or more different types of messages. For example, the queues may be provided by the transfer proxy functionality 206.

The interface circuitry 22 or means for communicating 22 may correspond to one or more inputs and/or outputs for receiving and/or transmitting information, which may be in digital (bit) values according to a specified code, within a module, between modules or between modules of different entities. For example, the interface circuitry 22 or means for communicating 22 may comprise circuitry configured to receive and/or transmit information.

For example, the processing circuitry 24 or means for processing 24 may be implemented using one or more processing units, one or more processing devices, any means for processing, such as a processor, a computer or a programmable hardware component being operable with accordingly adapted software. In other words, the described function of the processing circuitry 24 or means for processing may as well be implemented in software, which is then executed on one or more programmable hardware components. Such hardware components may comprise a general-purpose processor, a Digital Signal Processor (DSP), a micro-controller, etc.

For example, the storage circuitry 26 or means for storing information 26 may comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

For example, the edge server 200 may be a server computer system, i.e., a computer system being used to serve functionality, such as one or more instances of one or more microservices, to one or more client computers.

More details and aspects of the apparatus 20, device 20, method, of a corresponding computer program and of the edge server 200 are mentioned in connection with the proposed concept or one or more examples described above or below (e.g., FIG. 1a to 1b, 3 to 4). The apparatus 20, device 20, method, the corresponding computer program, and the edge server 200 may comprise one or more additional optional features corresponding to one or more aspects of the proposed concept, or one or more examples described above or below.

Various examples of the present disclosure relate to an automated tuning of a microservice cluster at the edge. In such scenarios, the cluster communication mechanism designed for cloud infrastructure might not work as well when they are deployed in the edge infrastructure, which may lead to instability or even cause exceptions in the microservice cluster.

In some systems, instable network conditions are dealt with by increasing the tolerance for abnormal transfers. For example, in Kubernetes, a microservice orchestration framework, the empirical parameters may be selected to match the network conditions of the nodes when deploying the cluster. To tolerate instable network among some edge nodes, loose parameters can be configured for these edge nodes. However, such statically configured parameters for coordinating the cluster might not be able cope with dynamically changing network conditions, which can occur in an edge computing scenario. Moreover, in many cases, microservice clusters use HTTP (HyperText Transfer Protocol)-based REST (Representational State Transfer) APIs (Application Programming Interfaces) and HTTP-based Streams as communication protocols. These protocol may be considered to not be efficient enough, as they require more bandwidth than other protocols. Also, they are not designed to handle various network exceptions, which may result in cluster instability and service exceptions.

In the present disclosure, a concept is proposed that uses different network protocols for edge nodes under different network situations. For example, REST APIs on HTTP/1 may be used for good quality networks (i.e., having a first network quality that is better than at least a second and a third network quality), gRPC (a Remote Procedure Call implementation by Google) on HTTP/2 for normal quality networks (i.e., having a second network quality that is better than at least a third and worse than a first network quality), MQTT (Message-Queuing Telemetry Transport) for poor quality network (i.e., having a third network quality that is worse than the first and second network quality), and payload compression for the worst quality network (i.e., having a fourth network quality that is worse than the first through third network quality). Moreover, different communication QoS (Quality of Service) strategies (i.e., prioritization strategies) may be used for edge nodes under different network condition. For example, the priority of urgent messages may be prioritized and the transfer of normal messages may be de-prioritized. Finally, in some examples, reinforcement learning may be applied to dynamically determine the communication protocol and QoS strategy for each edge node, making the solution adaptive to instable and fast changing edge network infrastructure. The proposed concept may be used to build robust and stable microservice clusters that can well adapt to any instable edge network infrastructure. Based the proposed concept, system integrators (SIs) can build PaaS (Platform as a Service) and SaaS (System as a Service) services with increased reliability at the on-premises edge.

In the proposed concept, the network protocol being used may change from time to time. Moreover, the status synchronization strategy of the microservice cluster may also change according to network conditions. Finally, different protocols may be used, which may be supported by protocol translation.

FIG. 3 shows a schematic diagram of an example of an on-premises edge-based microservice cluster. As shown in FIG. 3, a microservice cluster may comprise or consist of a control plane and edge worker nodes 330, 360. The control server 310 on the control plane communicates with control agents on the edge worker nodes to maintain the status of worker nodes and collect telemetry of services running on worker nodes. In this way, services can be orchestrated among worker nodes in cluster. For example, a RESTful API is the commonly used protocol in communication. In FIG. 3, some of the edge worker nodes 330 communicate among each other via a Local Area Network (LAN), and with the edge server 310 via Native Address Translation (NAT) via a firewall 320. Some other nodes 360 communicate among each other via a Local Area Network (LAN), and with the edge server 310 via a 5G (5-th Generation cellular network according to the 3rd-Generation Partnership Project (3GPP)) Access Point (AP)/Customer Premises Equipment (CPE) 350 and a base station 340.

The proposed concept provides two particular components, a Transfer Proxy and a Reinforcement Learning Engine. They collaborate with each other to configure an improved or optimal communication protocol and strategy (i.e., the network configuration) according to dynamically changing network conditions (i.e., the network quality) of each edge worker node. By switching to a different protocol, turning on/off payload compression and adjusting the priority of messages, an edge worker node can gain the capability of adapting to its changing network condition automatically, e.g., with the help from a reinforcement learning engine. To overcome the limitation that static empirical parameters cannot handle all the situations for all heterogeneous worker nodes under different network conditions well, parameter values are introduced for tuning on each node. This way, each node has its own set of improved or optimal parameters and can be continuously updated at runtime to handle any fluctuation in network quality. Moreover, the proposed concept does not modify any existing modules such as the control server, control agent and services etc., making it easy to be compatible with any microservice cluster.

FIG. 4 shows a schematic diagram of a microservice cluster communicating according to an example of the proposed concept. In FIG. 4, a control plane 410 (i.e., an edge server 410) and a plurality of worker nodes 420 are shown. The control plane 410 and the worker nodes 420 communicate via TCP/IP (Transmission Control Protocol/Internet Protocol) 411, 421. Inside the control plane, transfer proxies 412 are used between a control server 417 and the control agent 427 of the worker nodes. Inside the transfer proxies 412, queues 414 with different priorities are provided. A block 413 for setting the priority, compression and protocol controls payload compression/decompression 415, protocol encapsulation/decapsulation 416 and the queues 414. The block 413 for setting the priority, compression and protocol is controlled by an action provided by a reinforcement learning engine 420 of the respective worker node 420. Inside each worker node, a similar transfer proxy 422 is provided, with a block 423 for setting priority, compression and protocol, queues (with different priorities) 424, payload compression/decompression 425 and payload encapsulate/decapsulate 426. The transfer proxy 422 is used for the communication between the control agent 427 of the worker node 420 and the control server 417 of the control plane 410. Inside each worker node, the services 440 being provided are executed. The worker plane 420 further includes the reinforcement learning engine 430, which is used to control the blocks 413, 423 for setting the priority, compression and protocol. It includes an action agent 431, for generating the action (e.g., the selection of the network configuration) based on a state (e.g., the information on the network quality, provided by traffic measurement block 432) and based on a reward (provided by a reward calculator block 433). The traffic measurement performed by the traffic measurement block 432 is based on the TCP/IP block 421, and the reward calculated by the reward calculator block 433 is based on the state provided by the traffic measurement block 432 and based on the action generated by the action agent 431.

The respective transfer proxy 412, 422 takes over the transfer between the control agent 427 and the control server 417 in order to keep stable communication in instable and changing edge network infrastructures. So, one transfer proxy 422 is deployed on each worker node 420 and its peer 412 is deployed on the control plane 410. The proposed concept may use at least one of the following two mechanisms in the transfer proxy to ensure it is adaptive to the network situation.

For example, a dynamic transfer protocol may be used. Different protocols have different adaptations. Taking the most common protocols RESTful API, gRPC and MQTT as examples: RESTful APIs is based on the HTTP/1 protocol and provide simple and uniform interfaces to make data available via a web URL (Uniform Resource Locator). RESTful APIs are easy to understand, implement and extend. However, its web URL style may introduce redundant information, making it inefficient. gRPC, which is based on HTTP/2, uses tight packing of the protobuffer to overcome the speed and weight constraints, making gRPC more efficient and faster than RESTful APIs. MQTT is specifically improved or optimized for edge instable networks with limited bandwidth. It also provides QoS policies such as exact once, at least once, and at most once to guarantee the success of transfer. Its payload is binary, which makes it easy to support compressed payload to further save bandwidth.

In the proposed concept, four network conditions are defined: good (i.e., a first network quality), normal (i.e., a second network quality), poor (i.e., a third network quality) and worse (i.e., a fourth network quality). Based on the four network conditions, four protocols are mapped to these four network conditions. However, there are no hard limitation of protocols in the proposed concept. More protocols can be used if network conditions are defined more precisely.

For example, in good condition, RESTful APIs may be used. Since RESTful APIs are used by the control server and control agent, no additional protocol translation may be required. In normal conditions, gRPC may be used increase efficiency. In pool conditions, MQTT may be used in this instable network. In the worse case, the payload of MQTT may be compressed.

In addition to the use of a dynamic transfer protocol, or alternatively a dynamic communication QoS strategy may be used. Messages between worker node and control plane may be categorized into different types, such as the following four types: alert, control command, telemetry and logging/tracing. Accordingly, four FIFO queues 414, 424 may be used to buffer four types of messages with different priorities according to network conditions. In good conditions, the four FIFO queues have the same priority, and the messages in four queues are transferred in a round robin way. In normal conditions, the logging/tracing queue may be deprioritized to improve the chances of the other three queues. In poor conditions, the logging/tracing queue and telemetry queue may be deprioritized to improve the chances of the other two queues. In the worse/worst case, the logging/tracing, telemetry and control command queues may be deprioritized to ensure urgent alert to be successfully transferred. However, there is no hard limitation of priorities in this invention, more priorities (or fewer) can be defined if network conditions are defined more precisely.

In various examples of the present disclosure, a reinforcement learning engine 430 may be used to chose suitable parameters, protocol and QoS strategy, for the next sample interval, by sensing the current network condition and evaluating the effect of the previous parameter set. This engine is in charge of determining a specific action to be taken at next sample interval based on the collected state information (by traffic measurement block 432) and calculated reward result (by reward calculator 433). Then this specific action message may be conveyed to the transfer proxy 422 (or proxies, when on the same local network) on the worker node and its peer 412 on control plane to regulate the communication protocol and QoS strategy according to current variable network condition.

The reinforcement learning engine may comprise the following components: Araffic measurement 432 may be used to collect the needed state information including transfer retry count and success rate, e.g., for the four different kinds of messages. A Reward Calculator 433 may be used to calculate the reward based on the collected state information such as success rate and current action, and to send the reward to the action agent 431 for later action determination. An action agent 431 may rely on a DQN (Deep Q Network) algorithm and input state and reward information to find out optimal action with a maximal reward for the next sample interval

In order to well adapt to the changing network condition and provide fine-grained control on transfer proxy ensuring stable communication between nodes, an intelligent action agent with reinforce learning applied may be adopted in the system. As in edge scenarios, network condition will change sometimes very stochastically, to react quickly to the network fluctuation and predict more accurate action, in comparison with MOO (Multiple Objective Optimization) algorithms, DQN (Deep Q Network) learning, or more generally reinforcement learning, may be preferred. To improve the use of reinforcement learning, there are several key factors that may be well defined.

The action being provided by the action agent 431 may comprise the communication control and the communication QoS strategy as categories. For example, the communication control may be selected among RESTful API (HTTP/1), gRPC (HTTP/2), MQTT and MQTT with payload compression. For example, the communication QoS strategy may be selected among normal with no priority adjustment, deprioritize logging and tracing messages, deprioritize logging and tracing messages, telemetry, and deprioritize logging and tracing messages, thelemetry, and control commands. As there are two categories and 4 different actions for each category defined, totally there are 16 actions that can be triggered.

The state may include one or more of a transfer retry count transfer retry count for N sample windows, a success rate of logging and tracing messages within current interval, a success rate of telemetry messages within the current interval, a success rate of control commands within the current interval and a success rate of alert messages within the current interval. For example, the sample interval may be one or more minutes.

In an illustrative example, the reward may be calculated using equation (1):

$$R = {R}_{sr} + {R}_{proxy} \qquad ( 1 )$$

The reward comprises or consists of two parts—the reward of the success rate (Rₛᵣ) and the reward of the proxy complexity (R_{proxy}).

To determine the reward of the success rate, four telemetries regarding the success rate of four types of messages may be collected. Based on those four telemetries, equation 2 may be used to calculate the overall success rate.

$$S {R}_{overall} = \frac{{W}_{l} \cdot {SR}_{l} + {W}_{t} \cdot {SR}_{t} + {W}_{c} \cdot {SR}_{c} + {W}_{a} \cdot {SR}_{a}}{{W}_{l} + {W}_{t} + {W}_{c} + {W}_{a}} \qquad ( 2 )$$

Where SRₗ is the success rate of logging and tracing messages, Wₗ is the weight for the logging and tracing messages, SRₜ is the success rate of telemetry messages, Wₜ is the weight for the telemetry messages, SR_{c} is the weight for the control commands, W_{c} is the weight for the control commands, SRₐ is the success rate for alert messages, and Wₐ is the weight for the alert messages.

Based on the overall success rate, equation (3) may be used to calculate the reward of success rate.

$${R}_{sr} = \{ \begin{matrix}- {m}_{0} & if {SR}_{overall} < {th}_{0} \\ - {m}_{1} & if {SR}_{overall} < {th}_{1} \\ & … \\ - {m}_{n - 1} & if {SR}_{overall} < {th}_{n - 1} \\ + {m}_{n} & if {SR}_{overall} \geq {th}_{n - 1}\end{matrix} \qquad ( 3 )$$

m₀>m₁> . . . >mₙ₋₁ is used as the penalty when the overall success rate is lower than a predefined threshold thₙ₋₁ A positive mₙ is the reward when the success rate is higher than the predefined threshold.

Equation (4) may be used to calculate the reward of the proxy complexity, which is the sum of the reward of the protocol complexity and the reward of the QoS strategy:

$${R}_{proxy} = {R}_{protocol} + {R}_{strategy} \qquad ( 4 )$$

Particularly, if SRₒᵥₑᵣₐₗₗ>=th_{protocol}, meaning that the success rate is high, R_{protocol} can be calculated following equation (5):

$${R}_{protocol} = \{ \begin{matrix}- {n}_{0} if protocol is MQTT with payload compression ( most complex ) \\ - {n}_{1} if protocol is MQTT \\ - {n}_{2} if protocol is gRPC \\ + {n}_{3} if protocol is RESTful API ( least complex )\end{matrix} \qquad ( 5 )$$

With n₀>n₁>n₂ (>n₃).

If the overall success rate is low (SRₒᵥₑᵣₐₗₗ<th_{protocol}), R_{protocol} can be calculated following equation (6):

$${R}_{protocol} = \{ \begin{matrix}+ {n}_{0} if protocol is MQTT with payload compression ( most complex ) \\ - {n}_{1} if protocol is MQTT \\ - {n}_{2} if protocol is gRPC \\ - {n}_{3} if protocol is RESTful API ( least complex )\end{matrix} \qquad ( 6 )$$

With n₀<n₁<n₂<n₃.

Through the definition of R_{protocol}, the reward encourages to use a complex protocol when the success rate is low and discourages to use the complex protocol when success rate is high.

In the same way as R_{protocol}, if SRₒᵥₑᵣₐₗₗ>=th_{protocol}, meaning the success rate is high, R_{strategy} can be calculated following equation (7).

$${R}_{strategy} = \{ \begin{matrix}- {k}_{0} if the strategy is to deprioritize logging / tracing , telemetry and control com . \\ - {k}_{1} if the strategy is to deprioritize logging / tracing and telemetry \\ - {k}_{2} if the strategy is to deprioritize logging / tracing \\ + {k}_{3} if the strategy is normal\end{matrix} \qquad ( 7 )$$

With k₀>k₁>k₂>k₃.

If SRₒᵥₑᵣₐₗₗ<th_{protocol}, meaning the success rate is low, R_{strategy} can be calculated following equation (8).

$${R}_{strategy} = \{ \begin{matrix}+ {k}_{0} if the strategy is to deprioritize logging / tracing , telemetry and control com . \\ - {k}_{1} if the strategy is to deprioritize logging / tracing and telemetry \\ - {k}_{2} if the strategy is to deprioritize logging / tracing \\ - {k}_{3} if the strategy is normal\end{matrix} \qquad ( 8 )$$

With k₀<k₁<k₂<k₃.

Through the definition of R_{strategy}, the reward encourages to deprioritize unimportant messages when the success rate is low and discourages to deprioritize any message when the success rate is high.

To train the initial model for DQN, thousands of samples of data may be captured on a real machine by running microservice workloads in a cluster for several days. Each sample of data should may contain the current state S, current action A, the new state after action has been taken S′ and the reward R. With thousands of such samples of data (S, A, S′, R), the initial model can be trained out and be later deployed to the real environment.

At runtime, this model can continue to be updated with newly sampled datasets in the real environment. In detail, every time an agent determines the action for the next interval based on the current state, the new state information and reward may be collected at the next interval. This new record of (S, A, S′, R) may be captured and accumulated in a runtime dataset for later model re-training. An experience relay method may be applied occasionally, as it can reduce the memory consumption for saving runtime dataset. With this mechanism, and when the system runs for a long time, the agent or the model may tend to output an improved action with an increased or maximal reward at every interval.

More details and aspects of the concept for automated tuning of a microservice cluster at the edge are mentioned in connection with the proposed concept or one or more examples described above or below (e.g., FIG. 1a to 2b). The concept for automated tuning of a microservice cluster at the edge may comprise one or more additional optional features corresponding to one or more aspects of the proposed concept, or one or more examples described above or below.

An example (e.g., example 1) relates to an apparatus (10) for an edge worker node (100), the apparatus comprising interface circuitry (12), machine-readable instructions and processing circuitry (14) to execute the machine-readable instructions to determine information on a network quality of a network connection between the edge worker node (100) and an edge server (200). The machine-readable instructions comprise instructions to select, based on the network quality, a network configuration, the network configuration comprising at least one of a network protocol and a prioritization strategy for communicating via the network connection. The machine-readable instructions comprise instructions communicate via the network connection according to the selected network configuration.

Another example (e.g., example 2) relates to a previously described example (e.g., example 1) or to any of the examples described herein, further comprising that the machine-readable instructions comprise instructions to provide a transfer proxy functionality (106) for communicating via the network connection, the transfer proxy functionality being configured to transfer a payload via the network communication according to the selected network configuration.

Another example (e.g., example 3) relates to a previously described example (e.g., example 2) or to any of the examples described herein, further comprising that the machine-readable instructions comprise instructions to obtain, by the transfer proxy functionality, the payload to be transmitted via the network connection, and to encapsulate the payload and/or to prioritize transmission of the payload according to the selected network configuration.

Another example (e.g., example 4) relates to a previously described example (e.g., one of the examples 2 to 3) or to any of the examples described herein, further comprising that the machine-readable instructions comprise instructions to obtain, by the transfer proxy functionality, the payload to be transmitted via a Hypertext Transfer Protocol-based Representational State Transfer Application Programming Interface (HTTP REST API).

Another example (e.g., example 5) relates to a previously described example (e.g., one of the examples 1 to 4) or to any of the examples described herein, further comprising that the machine-readable instructions comprise instructions to provide information on the selected network configuration to the edge server.

Another example (e.g., example 6) relates to a previously described example (e.g., one of the examples 1 to 5) or to any of the examples described herein, further comprising that the machine-readable instructions comprise instructions to select the network protocol of the network configuration among a group of at least two network protocols.

Another example (e.g., example 7) relates to a previously described example (e.g., example 6) or to any of the examples described herein, further comprising that the group of at least two network protocols comprises two or more of a Hypertext Transfer Protocol-based Representational State Transfer Application Programming Interface (HTTP REST API)-based protocol, a Remote Procedure Call protocol, a Message-Queuing Telemetry Transport (MQTT) protocol, and a compressed MQTT protocol.

Another example (e.g., example 8) relates to a previously described example (e.g., one of the examples 1 to 7) or to any of the examples described herein, further comprising that the machine-readable instructions comprise instructions to select the prioritization strategy of the network configuration among a group of at least two pre-defined prioritization strategies.

Another example (e.g., example 9) relates to a previously described example (e.g., example 8) or to any of the examples described herein, further comprising that the group of at least two pre-defined prioritization strategies comprise a prioritization strategy wherein messages have the same priority, a prioritization strategy wherein logging and/or tracing messages are deprioritized, a prioritization strategy wherein logging and/or tracing messages and telemetry messages are deprioritized and a prioritization strategy wherein logging and/or tracing messages, telemetry messages and control command messages are deprioritized.

Another example (e.g., example 10) relates to a previously described example (e.g., one of the examples 1 to 9) or to any of the examples described herein, further comprising that the machine-readable instructions comprise instructions to provide two or more different prioritization queues (102, 104) for two or more different types of messages.

Another example (e.g., example 11) relates to a previously described example (e.g., one of the examples 1 to 10) or to any of the examples described herein, further comprising that the apparatus comprises memory circuitry comprising a machine-learning model, the machine-learning model being trained, using reinforcement learning, to select the network configuration according to a reward function.

Another example (e.g., example 12) relates to a previously described example (e.g., example 11) or to any of the examples described herein, further comprising that the reward function is based on a success rate of the communication and based on a complexity of the network configuration.

Another example (e.g., example 13) relates to a previously described example (e.g., example 12) or to any of the examples described herein, further comprising that the success rate is determined according to a weighted combination of success rates of different types of messages.

Another example (e.g., example 14) relates to a previously described example (e.g., one of the examples 12 to 13) or to any of the examples described herein, further comprising that the complexity of the network configuration is determined based on the selected network protocol and based on the selected prioritization strategy.

Another example (e.g., example 15) relates to a previously described example (e.g., one of the examples 12 to 14) or to any of the examples described herein, further comprising that the complexity of the network configuration is determined depending on the success rate, such that, depending on the success rate, a different combination of network protocol and prioritization strategy is prioritized.

Another example (e.g., example 16) relates to a previously described example (e.g., one of the examples 11 to 15) or to any of the examples described herein, further comprising that the machine-learning model is a pre-trained machine-learning model.

Another example (e.g., example 17) relates to a previously described example (e.g., example 16) or to any of the examples described herein, further comprising that the machine-readable instructions comprise instructions to refine the training of the pre-trained machine-learning model during operation of the worker node.

Another example (e.g., example 18) relates to a previously described example (e.g., one of the examples 1 to 17) or to any of the examples described herein, further comprising that the network connection is used for administrative communication among nodes of a cluster of microservices, the cluster of microservices comprising the edge worker node and the edge server.

Another example (e.g., example 19) relates to a previously described example (e.g., one of the examples 1 to 18) or to any of the examples described herein, further comprising that the machine-readable instructions comprise instructions to periodically reevaluate the network quality, and to repeat the selection of the network configuration based on the reevaluated network quality.

An example (e.g., example 20) relates to a computer system (100) comprising the apparatus (10) according to one of the examples 1 to 19 (or according to any other example), wherein the computer system (100) is the edge worker node (100).

An example (e.g., example 21) relates to an apparatus (20) for an edge server (200), the apparatus comprising interface circuitry (22), machine-readable instructions and processing circuitry (24) to execute the machine-readable instructions to obtain, from an edge worker node (100), information on a network configuration to be used for communicating, via a network connection, with an edge worker node, the network configuration comprising at least one of a network protocol and a prioritization strategy for communicating via the network connection, the network configuration being selected according to a network quality of the network connection. machine-readable instructions comprise instructions communicate via the network connection according to the selected network configuration.

Another example (e.g., example 22) relates to a previously described example (e.g., example 21) or to any of the examples described herein, further comprising that the machine-readable instructions comprise instructions to provide a transfer proxy functionality (206) for communicating via the network connection, the transfer proxy functionality being configured to transfer a payload via the network communication according to the selected network configuration.

Another example (e.g., example 23) relates to a previously described example (e.g., example 22) or to any of the examples described herein, further comprising that the machine-readable instructions comprise instructions to obtain, by the transfer proxy functionality, the payload to be transmitted via the network connection, and to encapsulate the payload and/or to prioritize transmission of the payload according to the selected network configuration.

Another example (e.g., example 24) relates to a previously described example (e.g., one of the examples 22 to 23) or to any of the examples described herein, further comprising that the machine-readable instructions comprise instructions to obtain, by the transfer proxy functionality, the payload to be transmitted via a Hypertext Transfer Protocol-based Representational State Transfer Application Programming Interface (HTTP REST API).

Another example (e.g., example 25) relates to a previously described example (e.g., one of the examples 22 to 24) or to any of the examples described herein, further comprising that the machine-readable instructions comprise instructions to obtain the information on the network configuration to be used from a plurality of different edge worker nodes, and to provide a separate instance of the transfer proxy functionality for each of the plurality of different edge worker nodes.

Another example (e.g., example 26) relates to a previously described example (e.g., one of the examples 21 to 25) or to any of the examples described herein, further comprising that the machine-readable instructions comprise instructions to provide two or more different prioritization queues (202, 204) for two or more different types of messages.

Another example (e.g., example 27) relates to a previously described example (e.g., one of the examples 21 to 26) or to any of the examples described herein, further comprising that the network connection is used for administrative communication among nodes of a cluster of microservices, the cluster of microservices comprising the edge worker node and the edge server.

An example (e.g., example 28) relates to a computer system (200) comprising the apparatus (20) according to one of the examples 21 to 27 (or according to any other example), wherein the computer system (200) is the edge server (200).

An example (e.g., example 29) relates to a system comprising the edge server (200) according to example 28 (or according to any other example) and one or more edge worker nodes (100) according to example 20 (or according to any other example).

An example (e.g., example 30) relates to an apparatus (10) for an edge worker node (100), the apparatus (10) comprising interface circuitry (12) and processing circuitry (14) to determine information on a network quality of a network connection between the edge worker node (100) and an edge server (200). The processing circuitry is to select, based on the network quality, a network configuration, the network configuration comprising at least one of a network protocol and a prioritization strategy for communicating via the network connection. The processing circuitry is to communicate via the network connection according to the selected network configuration.

An example (e.g., example 31) relates to a computer system (100) comprising the apparatus (10) according to example 30 (or according to any other example), wherein the computer system (100) is the edge worker node (100).

An example (e.g., example 32) relates to an apparatus (20) for an edge server (200), the apparatus comprising interface circuitry (22) and processing circuitry (24) to obtain, from an edge worker node (100), information on a network configuration to be used for communicating, via a network connection, with an edge worker node, the network configuration comprising at least one of a network protocol and a prioritization strategy for communicating via the network connection, the network configuration being selected according to a network quality of the network connection. The processing circuitry is to communicate via the network connection according to the selected network configuration.

An example (e.g., example 33) relates to a computer system (200) comprising the apparatus (20) according to example 32 (or according to any other example), wherein the computer system (200) is the edge server (200).

An example (e.g., example 34) relates to a system comprising the edge server (200) according to example 33 (or according to any other example) and one or more edge worker nodes (100) according to example 31 (or according to any other example).

An example (e.g., example 35) relates to a device (10) for an edge worker node (100), the device comprising means for communicating (12) and means for processing (14) for determining information on a network quality of a network connection between the edge worker node (100) and an edge server (200). The means for processing is for selecting, based on the network quality, a network configuration, the network configuration comprising at least one of a network protocol and a prioritization strategy for communicating via the network connection. The means for processing is for communicating via the network connection according to the selected network configuration.

An example (e.g., example 36) relates to a computer system (100) comprising the device (10) according to example 35, wherein the computer system (100) is the edge worker node (100).

An example (e.g., example 37) relates to a device (20) for an edge server (200), the device comprising means for communicating (22) and means for processing (24) for obtaining, from an edge worker node (100), information on a network configuration to be used for communicating, via a network connection, with an edge worker node, the network configuration comprising at least one of a network protocol and a prioritization strategy for communicating via the network connection, the network configuration being selected according to a network quality of the network connection. The means for processing is for communicating via the network connection according to the selected network configuration.

An example (e.g., example 38) relates to a computer system (200) comprising the device (20) according to example 37 (or according to any other example), wherein the computer system (200) is the edge server (200).

An example (e.g., example 39) relates to a system comprising the edge server (200) according to example 38 (or according to any other example) and one or more edge worker nodes (100) according to example 36 (or according to any other example).

An example (e.g., example 40) relates to a method for an edge worker node (100), the method comprising determining (110) information on a network quality of a network connection between the edge worker node (100) and an edge server (200). The method comprises selecting (120), based on the network quality, a network configuration, the network configuration comprising at least one of a network protocol and a prioritization strategy for communicating via the network connection. The method comprises communicating (160) via the network connection according to the selected network configuration.

Another example (e.g., example 41) relates to a previously described example (e.g., example 40) or to any of the examples described herein, further comprising that the method comprises providing (150) a transfer proxy functionality (106) for communicating via the network connection, the transfer proxy functionality being configured to transfer a payload via the network communication according to the selected network configuration.

Another example (e.g., example 42) relates to a previously described example (e.g., example 41) or to any of the examples described herein, further comprising that the method comprises obtaining (152), by the transfer proxy functionality, the payload to be transmitted via the network connection, and encapsulating (154) the payload and/or prioritizing (156) transmission of the payload according to the selected network configuration.

Another example (e.g., example 43) relates to a previously described example (e.g., one of the examples 41 to 42) or to any of the examples described herein, further comprising that the method comprises obtaining (152), by the transfer proxy functionality, the payload to be transmitted via a Hypertext Transfer Protocol-based Representational State Transfer Application Programming Interface (HTTP REST API).

Another example (e.g., example 44) relates to a previously described example (e.g., one of the examples 40 to 43) or to any of the examples described herein, further comprising that the method comprises providing (140) information on the selected network configuration to the edge server.

Another example (e.g., example 45) relates to a previously described example (e.g., one of the examples 40 to 44) or to any of the examples described herein, further comprising that the method comprises selecting (122) the network protocol of the network configuration among a group of at least two network protocols.

Another example (e.g., example 46) relates to a previously described example (e.g., one of the examples 40 to 45) or to any of the examples described herein, further comprising that the method comprises selecting (124) the prioritization strategy of the network configuration among a group of at least two pre-defined prioritization strategies.

Another example (e.g., example 47) relates to a previously described example (e.g., one of the examples 40 to 48) or to any of the examples described herein, further comprising that the method comprises providing (130) two or more different prioritization queues (102, 104) for two or more different types of messages.

Another example (e.g., example 48) relates to a previously described example (e.g., one of the examples 40 to 49) or to any of the examples described herein, further comprising that the method comprises using a machine-learning model to select (120) the network configuration, the machine-learning model being trained, using reinforcement learning, to select the network configuration according to a reward function.

Another example (e.g., example 49) relates to a previously described example (e.g., example 48) or to any of the examples described herein, further comprising that the method comprises refining (180) a training of the pre-trained machine-learning model during operation of the worker node.

Another example (e.g., example 50) relates to a previously described example (e.g., one of the examples 40 to 49) or to any of the examples described herein, further comprising that the method comprises periodically reevaluating (170) the network quality and repeating the selection (120) of the network configuration based on the reevaluated network quality.

An example (e.g., example 51) relates to a computer system (100) being configured to perform the method according to one of the examples 40 to 50 (or according to any other example), wherein the computer system (100) is the edge worker node (100).

An example (e.g., example 52) relates to a method for an edge server (200), the method obtaining (210), from an edge worker node (100), information on a network configuration to be used for communicating, via a network connection, with an edge worker node, the network configuration comprising at least one of a network protocol and a prioritization strategy for communicating via the network connection, the network configuration being selected according to a network quality of the network connection. The method comprises communicating (240) via the network connection according to the selected network configuration.

Another example (e.g., example 53) relates to a previously described example (e.g., example 52) or to any of the examples described herein, further comprising that the method comprises providing (230) a transfer proxy functionality (106) for communicating via the network connection, the transfer proxy functionality being configured to transfer a payload via the network communication according to the selected network configuration.

Another example (e.g., example 54) relates to a previously described example (e.g., example 53) or to any of the examples described herein, further comprising that the method comprises obtaining (232), by the transfer proxy functionality, the payload to be transmitted via the network connection, and encapsulating (234) the payload and/or prioritizing (236) transmission of the payload according to the selected network configuration.

Another example (e.g., example 55) relates to a previously described example (e.g., one of the examples 53 to 54) or to any of the examples described herein, further comprising that the method comprises obtaining (232), by the transfer proxy functionality, the payload to be transmitted via a Hypertext Transfer Protocol-based Representational State Transfer Application Programming Interface (HTTP REST API).

Another example (e.g., example 56) relates to a previously described example (e.g., one of the examples 53 to 55) or to any of the examples described herein, further comprising that the method comprises obtaining (210) the information on the network configuration to be used from a plurality of different edge worker nodes, and providing (230) a separate instance of the transfer proxy functionality for each of the plurality of different edge worker nodes.

Another example (e.g., example 57) relates to a previously described example (e.g., one of the examples 52 to 56) or to any of the examples described herein, further comprising that the method comprises providing (220) two or more different prioritization queues (202, 204) for two or more different types of messages.

An example (e.g., example 58) relates to a computer system (200) being configured to perform the method according to one of the examples 52 to 57 (or according to any other example), wherein the computer system (200) is the edge server (200).

An example (e.g., example 59) relates to a system comprising the edge server (200) according to example 58 (or according to any other example) and one or more edge worker nodes (100) according to example 51 (or according to any other example).

An example (e.g., example 60) relates to a non-transitory machine-readable storage medium including program code, when executed, to cause a machine to perform the method of one of the examples 40 to 50 (or according to any other example) or the method according to one of the examples 52 to 57 (or according to any other example).

An example (e.g., example 61) relates to a computer program having a program code for performing the method of one of the examples 40 to 50 (or according to any other example) or the method according to one of the examples 52 to 57 (or according to any other example) when the computer program is executed on a computer, a processor, or a programmable hardware component.

An example (e.g., example 62) relates to a machine-readable storage including machine readable instructions, when executed, to implement a method or realize an apparatus as claimed in any pending claim or shown in any example

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F) PLAs), (field) programmable gate arrays ((F) PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

1. An apparatus for an edge worker node, the apparatus comprising interface circuitry, machine-readable instructions and processing circuitry to execute the machine-readable instructions to:
determine information on a network quality of a network connection between the edge worker node and an edge server;
select, based on the network quality, a network configuration, the network configuration comprising at least one of a network protocol and a prioritization strategy for communicating via the network connection; and
communicate via the network connection according to the selected network configuration.

2. The apparatus according to claim 1, wherein the machine-readable instructions comprise instructions to provide a transfer proxy functionality for communicating via the network connection, the transfer proxy functionality being configured to transfer a payload via the network communication according to the selected network configuration.

3. The apparatus according to claim 2, wherein the machine-readable instructions comprise instructions to obtain, by the transfer proxy functionality, the payload to be transmitted via the network connection, and to encapsulate the payload and/or to prioritize transmission of the payload according to the selected network configuration.

4. The apparatus according to claim 2, wherein the machine-readable instructions comprise instructions to obtain, by the transfer proxy functionality, the payload to be transmitted via a Hypertext Transfer Protocol-based Representational State Transfer Application Programming Interface (HTTP REST API).

5. The apparatus according to claim 1, wherein the machine-readable instructions comprise instructions to provide information on the selected network configuration to the edge server.

6. The apparatus according to claim 1, wherein the machine-readable instructions comprise instructions to select the network protocol of the network configuration among a group of at least two network protocols.

7. The apparatus according to claim 1, wherein the machine-readable instructions comprise instructions to select the prioritization strategy of the network configuration among a group of at least two pre-defined prioritization strategies.

8. The apparatus according to claim 1, wherein the machine-readable instructions comprise instructions to provide two or more different prioritization queues for two or more different types of messages.

9. The apparatus according to claim 1, wherein the apparatus comprises memory circuitry comprising a machine-learning model, the machine-learning model being trained, using reinforcement learning, to select the network configuration according to a reward function.

10. The apparatus according to claim 9, wherein the reward function is based on a success rate of the communication and based on a complexity of the network configuration.

11. The apparatus according to claim 10, wherein the success rate is determined according to a weighted combination of success rates of different types of messages.

12. The apparatus according to claim 10, wherein the complexity of the network configuration is determined based on the selected network protocol and based on the selected prioritization strategy.

13. The apparatus according to claim 10, wherein the complexity of the network configuration is determined depending on the success rate, such that, depending on the success rate, a different combination of network protocol and prioritization strategy is prioritized.

14. The apparatus according to claim 9, wherein the machine-learning model is a pre-trained machine-learning model, wherein the machine-readable instructions comprise instructions to refine the training of the pre-trained machine-learning model during operation of the worker node.

15. The apparatus according to claim 1, wherein the network connection is used for administrative communication among nodes of a cluster of microservices, the cluster of microservices comprising the edge worker node and the edge server.

16. An apparatus for an edge server, the apparatus comprising interface circuitry, machine-readable instructions and processing circuitry to execute the machine-readable instructions to:
obtain, from an edge worker node, information on a network configuration to be used for communicating, via a network connection, with an edge worker node, the network configuration comprising at least one of a network protocol and a prioritization strategy for communicating via the network connection, the network configuration being selected according to a network quality of the network connection; and
communicate via the network connection according to the selected network configuration.

17. The apparatus according to claim 16, wherein the machine-readable instructions comprise instructions to provide a transfer proxy functionality for communicating via the network connection, the transfer proxy functionality being configured to transfer a payload via the network communication according to the selected network configuration.

18. The apparatus according to claim 17, wherein the machine-readable instructions comprise instructions to obtain, by the transfer proxy functionality, the payload to be transmitted via the network connection, and to encapsulate the payload and/or to prioritize transmission of the payload according to the selected network configuration.

19. The apparatus according to claim 16, wherein the machine-readable instructions comprise instructions to obtain the information on the network configuration to be used from a plurality of different edge worker nodes, and to provide a separate instance of the transfer proxy functionality for each of the plurality of different edge worker nodes.

20-24. (canceled)

25. A non-transitory machine-readable storage medium including program code, when executed, to cause a machine to perform a method for an edge worker node, the method comprising:
determining information on a network quality of a network connection between the edge worker node and an edge server;
selecting, based on the network quality, a network configuration, the network configuration comprising at least one of a network protocol and a prioritization strategy for communicating via the network connection; and
communicating via the network connection according to the selected network configuration.
